(19) United States
(12) Patent Application Publication
(10) Pub. No.: US 2024/0325999 A1
(43) Pub. Date: Oct. 3, 2024

(54) AUTOMATED TANK MIXING FOR CUSTODY TRANSFER

(71) Applicant: PHILLIPS 66 COMPANY, HOUSTON, TX (US)

(72) Inventors: Luke Schnefke, Houston, TX (US); Victor Cedillo, Cypress, TX (US); Patrick David, Houston, TX (US); Matt Clowe, Cypress, TX (US)

(73) Assignee: PHILLIPS 66 COMPANY, HOUSTON, TX (US)

(21) Appl. No.: 18/619,576

(22) Filed: Mar. 28, 2024

Related U.S. Application Data
(60) Provisional application No. 63/492,660, filed on Mar. 28, 2023.

(51) Int. Cl. B01F 35/22; B01F 35/21; B01F 35/221

(52) U.S. Cl. CPC B01F 35/2209; B01F 35/2112; B01F 35/2206; B01F 35/22161

(57) ABSTRACT

Methods and systems for intermittently mixing a fluid in a tank based on information received from at least two data acquisition devices that are vertically spaced on the tank and capable of obtaining at least one property or characteristic of the fluid that is in the tank and adjacent to each data acquisition device. A data analyzer compares data measurements received from the data acquisition devices and intermittently operates a mixer to maintain homogeneity of at least one chemical characteristic or physical property of the fluid both prior to and during dispensing of the fluid from the tank. The method further utilizes information received from the at least two data acquisition devices to assist in calculating a volume of fluid dispensed from the tank.

### CROSS-REFERENCE TO RELATED APPLICATIONS

This application is a non-provisional application or continuation-in-part application which claims the benefit of and priority to U.S. Provisional Application Ser. No. 63/491,660 filed Mar. 28, 2023, entitled “Automated Tank Mixing for Custody Transfer,” which is hereby incorporated by reference in its entirety.

### STATEMENT REGARDING FEDERALLY SPONSORED RESEARCH OR DEVELOPMENT

None.

### FIELD OF THE INVENTION

Method and systems for maintaining the homogeneity of a hydrocarbon fluid for custody transfer.

### BACKGROUND OF THE INVENTION

Industrial facilities, such as refineries and midstream assets, utilize highly complex machines, devices and systems and highly complex workflows, in which operators must account for a host of parameters to optimize design, development, deployment, and operation of different technologies and improve overall production and profit. For example, within tanks, fluid data has historically been collected by human beings using dedicated data collectors that often record batches of specific sensor data for later analysis. Batches of data have historically been returned to a central office for analysis, such as undertaking signal processing or other analysis on the data collected by various sensors, after which analysis can be used as a basis for diagnosing problems in an environment and/or suggesting ways to improve operations. This work has historically taken place on a time scale of weeks or months and has been directed to limited data sets.

In an oil and gas facilities, crude oil and product storage tanks are very important factors in predicable and continuous production. Crude oils are generally received in large storage tanks from ships via pipelines for further processing. The storage tanks are often equipped with mixers, primarily to avoid settling/layering of sludge inside the tank. These mixers are operated to obtain a homogeneous blend of different crude oils with respect to basic sediment, water content and density. A homogeneous crude oil blend is desirable for consistent operation of downstream refining units. The homogeneity of a given crude oil blend can be determined based on variations in different density measurements obtained from a crude oil storage tank, such as three separate measurements of crude oil density taken from locations near the top, middle elevation, and bottom of the tank. This results in a numerous measurements to be analyzed.

The emergence of the Internet of Things (IoT) has made it possible to connect continuously to, and among, a much wider range of devices. Within refineries the range of available data is often limited, and the complexity of dealing with data from multiple sensors makes it much more difficult to produce “smart” solutions that are effective for the industrial sector. Improved visibility of data and issues should enable better and quicker decision-making leading to operational efficiencies, higher production levels, improved safety, and cost savings.

A need exists for improved methods and systems for data collection in industrial environments, as well as for improved methods and systems for using collected data to provide improved monitoring, control, intelligent diagnosis of problems and intelligent optimization of operations in various heavy industrial environments such as refineries and their crude oil and product storage tanks.

### BRIEF SUMMARY OF THE DISCLOSURE

Some embodiments comprise a method that comprises: flowing a volume of hydrocarbon fluid into a tank; operating an upper data acquisition device positioned on the tank to obtain a first measurement of at least one physical property, at least one chemical characteristic, or at least one physical property and at least one chemical characteristic of the fluid that is adjacent to the upper data acquisition device; operating a lower data acquisition device, positioned on the tank below the height of the upper data acquisition device, to obtain a second measurement at least one physical property, at least one chemical characteristic, or at least one physical property and at least one chemical characteristic of the fluid that is adjacent to the lower data acquisition device; utilizing a data analyzer to: receive and compare the first measurement and the second measurement; generate a data packet that contains a calculated operational speed and operational time needed for an intermittent mixer to mix the fluid so that the first measurement is within a pre-defined range of proximity to the second measurement; and transmitting the data packet to the intermittent mixer, automatically turning on the intermittent mixer in response to information in the data packet that indicates the first measurement exceeds a pre-defined percentage difference relative to the second measurement; automatically turning off the intermittent mixer in response to information in the data packet that indicates the first measurement is within a pre-defined percentage difference to the second measurement; flowing a volume of fluid from the tank.

Some embodiments further comprise calculating an initial height of the fluid contained within the tank prior to the flowing of the volume of fluid from the tank and calculating a secondary height of the fluid within the tank after the flowing of the volume of fluid from the tank, wherein the volume of fluid flowed from the tank is calculated based on the initial height and the secondary height.

In some embodiments, the hydrocarbon fluid is selected from the group consisting of gasoline, diesel fuel, heating oil, jet fuel, petrochemical feedstocks, waxes, lubricating oils, asphalt, and combinations thereof.

In some embodiments, the at least one chemical characteristic and/or physical property is selected from the group consisting of: density, specific gravity, temperature, specific volume, viscosity, molecular weight, flash temperature, octane number, research octane number, motor octane number, antiknock index, boiling point, molecular type composition, elemental composition, freezing point, carbon residue, pour point, cloud point, vapor pressure, Reid vapor pressure, flammability range, wax and asphaltene content, cetane number, aniline point, carbon-to-hydrogen ratio, additive ratio, and combinations thereof.

In some embodiments, each data acquisition device intermittently or continuously measures the at least one chemical characteristic, at least one physical property or the at least one chemical characteristic and at least one physical property of the hydrocarbon fluid.

In some embodiments, the hydrocarbon fluid is an emulsion. In some embodiments, the hydrocarbon fluid is a slurry. In some embodiments, at least one of the upper data acquisition device, the lower data acquisition device, and the data analyzer, is an API approved custody transfer metering device.

In some embodiments, the pre-defined percentage difference between the first and the second measurements is selected from the list consisting of: less than 0.01% difference, less than 0.05% difference, less than 0.1% difference, less than 0.5% difference, less than 1% difference, less than 2% difference, less than 3% difference, less than 4% difference less than 5% difference, less than 6% difference, less than 7% difference, less than 8% difference, less than 9% difference, less than 10% difference, less than 15% difference, less than 20% difference, less than 25% difference, less than 30% difference, less than 45% difference, or less than 50% difference.

An alternative embodiment of the method comprises: flowing a volume of hydrocarbon fluid into a tank; operating an upper data acquisition device positioned on the tank to obtain a first density measurement of the hydrocarbon fluid that is adjacent to the upper data acquisition device; operating a lower data acquisition device, positioned on the tank below the height of the upper data acquisition device, to obtain a second density measurement of the fluid that is adjacent to the lower data acquisition device; utilizing a data analyzer to: receive and compare the first density measurement and the second density measurement; generate a data packet that contains a calculated operational speed and operational time needed for an intermittent mixer to mix the fluid so that the first density measurement is within a pre-defined range of proximity to the second density measurement; and transmit the data packet to the intermittent mixer; automatically turning on the intermittent mixer in response to information in the data packet that indicates the first density measurement exceeds a pre-defined range of density relative to the second density measurement; automatically turning off the intermittent mixer in response to information in the data packet that indicates the first measurement is within a pre-defined range of density relative to the second density measurement, then flowing a volume of fluid from the tank.

Some embodiments further comprise calculating an initial height of the fluid contained within the tank prior to the flowing of the volume of fluid from the tank and calculating a secondary height of the fluid within the tank after the flowing of the volume of fluid from the tank, wherein the volume of fluid flowed from the tank is calculated based on the initial height and the secondary height.

In some embodiments of the method, the pre-defined range between the first and the second density measurements is selected from the list consisting of: less than 0.01% difference, less than 0.05% difference, less than 0.1% difference, less than 0.5% difference, less than 1% difference, less than 2% difference, less than 3% difference, less than 4% difference less than 5% difference, less than 6% difference, less than 7% difference, less than 8% difference, less than 9% difference, less than 10% difference, less than 15% difference, less than 20% difference, less than 25% difference, less than 30% difference, less than 45% difference, or less than 50% difference. In some embodiments of the method, the pre-defined range between the first and the second density measurements is selected from the list consisting of: less than 0.001 kg/m³, 0.005 kg/m³, less than 0.01 kg/m³, less than 0.5 kg/m³, less than 0.1 kg/m³, less than 0.2 kg/m³, less than 0.4 kg/m³, less than 0.5 kg/m³, less than 1 kg/m³ and less than 5 kg/m³.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a flow diagram outlining an embodiment of the described processes and systems.

FIG. 2 depicts a flow diagram outlining an embodiment of the described processes and systems.

FIG. 3 depicts a flow diagram outlining an embodiment of the described processes and systems.

### DETAILED DESCRIPTION

Turning now to the detailed description of the preferred arrangement or arrangements of the present invention, in some embodiments, the present system describes a system wherein a first fluid is contained within a tank. An intermittent mixer is used for mixing or agitating the fluid within the tank. At least one data acquisition device within the tank can obtain a measurement (or repeated intermittent measurements) of at least one physical property or chemical characteristic within the fluid. In the embodiment, at least one data analyzer is capable of receiving the measurement(s), comparing the characteristics within the first fluid to the characteristics of a second fluid, generating a data packet that contains a calculated operational speed and an operational time needed for an intermittent mixer to mix or agitate the first fluid to obtain the characteristics of the second fluid and transmitting the data packet to the intermittent mixer. In this system the intermittent mixer improves consistency of the at least one chemical characteristic or physical property the first fluid within the tank to be more similar to the second fluid.

In some embodiments, the system described maintains a hydrocarbon emulsion with a tank. An intermittent mixer is used for agitating the hydrocarbon emulsion within the tank. An upper data acquisition device is capable of obtaining a first density measurement of the hydrocarbon emulsion in the tank adjacent to the upper data acquisition device. A lower data acquisition device situated below the upper data acquisition device is capable of obtaining a second density measurement of the hydrocarbon emulsion in the tank adjacent to the lower data acquisition device. In this embodiment, at least one data analyzer device is capable of receiving and comparing the first density measurement and the second density measurement, then generating a data packet that contains a calculated operational speed and an operational time needed for the intermittent mixer to agitate the hydrocarbon emulsion so that the first density measurement from the upper data acquisition device approximates the second density measurement obtained from the lower data acquisition device, and transmitting the data packet to the intermittent mixer. In this application, the term “approximates” is defined as when the density value obtained from the upper data acquisition device and the lower data acquisition device are both within a pre-defined range of proximity that may be measured in absolute density units or as a percentage (e.g., 10%, 5%, 2%, 1%, etc.) relative to each other.

Some embodiments comprise a method for maintaining a fluid within a tank. In this method an upper data acquisition device is operated to obtain a first measurement of at least one physical property or chemical characteristic of the fluid in a tank adjacent to the upper data acquisition device. A lower data acquisition device is also operated that is situated below the upper data acquisition device and operate operated to obtain a second measurement at least one physical property and/or chemical characteristic of the fluid in the tank adjacent to the lower data acquisition device. A data analyzer is then utilized that is capable of: receiving the first measurement and the second measurement, comparing the first measurement and the second measurement, generating a data packet that contains the calculated operational speed and estimated operational time needed for an intermittent mixer to mix or agitate the fluid so that the first measurement approximates the second measurement within a pre-defined range of proximity for the at least one measured physical property or chemical characteristic, then transmitting the data packet to the intermittent mixer. The method automatically turns off the intermittent mixer when a data packet received from the data analyzer indicates that the first measurement approximates the second measurement. In this application, the term “approximates” is defined as when the first measurement and the second measurement are both within a pre-defined range of proximity that may be measured in absolute units for the physical property and/or chemical characteristic, or as a percentage difference (e.g., 10%, 5%, 2%, 1%, etc.) relative to each other. The method then automatically tuns on the intermittent mixer from the data received from the data packet. In this method, the intermittent mixer operates to mix the fluid within the tank, thereby altering the fluid so the at the least one physical property or chemical characteristic of the fluid is more consistent throughout the tank.

Another embodiment comprises a method for maintaining a hydrocarbon emulsion in a tank. In this method, an upper data acquisition device is operated to obtain a first density measurement of the hydrocarbon emulsion in a tank adjacent to the upper data acquisition device. A lower data acquisition device is situated below the upper data acquisition device and is capable of obtaining a second density measurement of the hydrocarbon emulsion in the tank adjacent to the lower data acquisition device. A data analyzer is utilized that is capable of receiving the first density measurement and the second density measurement, capable of comparing the first density measurement and the second density measurement, capable of generating a data packet that comprises a calculated operational speed and an estimated operational time needed for the intermittent mixer to agitate the hydrocarbon emulsion such that that the first density measurement approximates the second density measurement, and capable of transmitting the data packet to the intermittent mixer. The intermittent mixer is then automatically turned on based of the information received from the data packet.

The intermittent mixer is later automatically turned off based of the information received from the data packet when the first density measurement from the upper data acquisition device approximates the second density measurement from the lower data acquisition device to within a pre-defined range of proximity that may be measured in absolute density units, or as a percentage difference (e.g., 10%, 5%, 2%, 1%, etc.) between the first and the second density measurements. In this method, the intermittent mixer maintains the density of the hydrocarbon emulsion within the tank so that it is consistent throughout the tank. The intermittent mixer is only turned on when the difference between the first density measurement and the second density measurement is outside of the pre-defined density range or exceed a threshold percentage difference in density, that indicates a lack of homogeneity throughout the entire volume of fluid held in the tank.

In some embodiments, the method comprises flowing a fluid into a tank, wherein the fluid is a hydrocarbon fluid. An initial height of the fluid is then calculated. An upper data acquisition device is then operated to obtain a first measurement of at least one characteristic or property of the fluid in the tank adjacent to the upper data acquisition device. A lower data acquisition device that is situated below the upper data acquisition device is capable is then operated to obtain a second measurement the at least one chemical characteristic or physical property of the fluid in the tank adjacent to the lower data acquisition device. A data analyzer is then operated to receive and compare the first measurement to the second measurement, then generate a data packet based on the comparison of the first measurement to the second measurement, wherein the data packet comprises a calculated operational speed and an operational time needed for the intermittent mixer to mix or agitate the fluid so that the value of the first measurement approximates the value of the second measurement to within a pre-defined range of proximity that may be measured in absolute units of the chemical characteristic or physical property, or measured as a percentage difference between the two measurements for the chemical characteristic or physical property. The data analyzer then transmits the data packet to the intermittent mixer to control the operation of the intermittent mixer.

The intermittent mixer is turned on automatically in response to the information received from the data packet when the difference between the two measurements exceeds the pre-defined range of proximity for the chemical characteristic or physical property. Once the data analyzer calculates and determines that the difference between the first measurement and the second measurement is within the pre-defined range of proximity, the data analyzer sends a data packet to the intermittent mixer, and optionally, to a control valve that opens to dispense a volume of fluid from the tank, wherein the at least one chemical characteristic or physical property is consistent throughout the dispensed volume of fluid. A secondary height of the fluid within the tank is then calculated, wherein the volume of the fluid dispensed from the tank is calculated based upon the initial height and the secondary height.

In some embodiments, the method comprises flowing a fluid into a tank, wherein the fluid is a hydrocarbon fluid. An initial height of the fluid is then calculated. An upper data acquisition device is then operated to obtain a first density measurement of the fluid in the tank adjacent to the upper data acquisition device. A lower data acquisition device that is situated below the upper data acquisition device is capable is then operated to obtain a second density measurement of the fluid in the tank adjacent to the lower data acquisition device. A data analyzer is then operated to receive and compare the first density measurement to the second density measurement, then generate a data packet based on the comparison of the first density measurement to the second density measurement, wherein the data packet comprises a calculated operational speed and estimated operational time needed for the intermittent mixer to mix or agitate the fluid so that the value of the first density measurement approximates the value of the second measurement to within a pre-defined range of proximity of acceptable variation in density that may be measured in absolute density units, or measured as a percentage difference between the two density measurements. The data analyzer then transmits the data packet to the intermittent mixer to control the operation of the intermittent mixer.

The intermittent mixer is turned on automatically in response to the information received from the data packet when the difference between the two measurements exceeds the pre-defined range of proximity for acceptable variation in density of the hydrocarbon fluid. Once the data analyzer calculates and determines that the difference between the first measurement and the second measurement is within the pre-defined range of proximity, the data analyzer sends a data packet to a control valve that opens to dispense a volume of fluid from the tank, wherein the at least one chemical characteristic or physical property is consistent throughout the dispensed volume of fluid. The control valve is then closed A secondary height of the fluid within the tank is then calculated, wherein the volume of the fluid dispensed from the tank is calculated based upon the initial height and the secondary height.

In some embodiments, the fluid is a hydrocarbon product. Examples of the fluid include, but are not limited to, gasoline, diesel fuel, heating oil, jet fuel, petrochemical feedstocks, waxes, lubricating oils, asphalt, and combinations thereof. In some embodiments the fluid is an emulsion and or a slurry. In some embodiments, the fluid is a hydrocarbon emulsion comprising gasoline, diesel fuel, heating oil, jet fuel, petrochemical feedstocks, waxes, lubricating oils, asphalt, and combinations thereof. In some embodiments, the hydrocarbon emulsion is a comprises both 1) non-polar hydrocarbons typically found in a refinery process and 2) polar substances such as water or wastewater.

In some embodiments, the tank is any of a variety of storage tanks capable of storing crude oil and/or hydrocarbon products derived from crude oil that are typically found in a refinery or a terminal. The liquid held within the tank is typically stored prior to being dispensed for processing, for blending with other fluids, or for shipping to a commercial market.

The mixer described herein may comprise any type of automated mixer that is suitable for mixing liquid contents within a tank and the mixer may be placed or arranged in any configuration suitable to effectively mix the tank contents. In some embodiments, the angle of the mixer blades may be variable, and the rotation of the blades around the mixer axis may be variable. The rotational angle of the mixer in the tank may be altered based on the desired mixing results.

In some embodiments, the mixer is operable to be turned on and off based upon information received from the data packet. Historically, mixers are constantly left on in the tanks in refineries or terminals. This accounts for significant energy usage at a refinery or terminal. Discontinuing mixing when unneeded significantly decreases electrical energy usage as well as mechanical wear on mixer bearings, motors, etc. Utilizing the combination of at least one data acquisition device and at least one data analyzer ensures that the fluid within the tank will maintain the properties of a consistent hydrocarbon emulsion throughout the tank. This consistent hydrocarbon emulsion also ensures that the process of performing a hydrocarbon fluid commercial custody transfer is faster, since operators do not have to wait for the hydrocarbon emulsion to settle or to constantly run the mixers. Furthermore, periodic, repeated measurements of at least one physical property or chemical characteristic in the tank allows custody transfer to begin as soon as the density measurements are found to be consistent throughout the tank. Also, in some embodiments at least one data acquisition device can be used to accurately measure the height of fluid within a tank, and therefore the volume dispensed, since one would know the height at which a data acquisition device was placed and whether the data acquisition device detected the presence of fluid at that location.

In some embodiments, the at least one data acquisition device detects at least one chemical characteristic of the fluid. Alternatively, the at least one data acquisition device detects at least one physical property of the fluid. In other embodiments, it is envisioned that the at least one data acquisition device detects multiple physical properties and/or multiple characteristics of the fluid simultaneously. Examples of characteristics and physical properties of the fluid that the at least one data acquisition device measures include (but is not limited to) density, specific gravity, temperature, specific volume, viscosity, molecular weight, flash temperature, octane numbers, research octane numbers, motor octane numbers, antiknock index, boiling point, molecular type compositions, elemental analysis, freezing point, carbon residue, pour point, cloud point, vapor pressure, reid vapor pressure, flammability range, wax and asphaltene contents, cetane number, aniline point, carbon-to-hydrogen ratios, additive ratios, and combinations thereof.

In some embodiments, the property or characteristic measured by the at least one data acquisition device can be measured either continuously or intermittently. In some embodiments, the at least one data acquisition device is an approved American Petroleum Institute custody transfer metering device. In some embodiments, the at least one data analyzer is an approved American Petroleum Institute custody transfer metering device.

While the novel method and system can operate with just one data acquisition device that detects variations in the at least one characteristic via continuous or periodic measurements obtained over time, the operability of the method and system can also operate with multiple data acquisition devices. For example, in one embodiment, the tank can situate one data acquisition device near the bottom of the tank and another data acquisition device near the top of the tank to obtain a full analysis of homogeneity of the at least one physical property or chemical characteristic throughout the tank.

Some embodiments situate, locate, position or arrange a series of data acquisition devices at different locations vertically spaced along the tank. For example, in one embodiment a first data acquisition device may be located at or near the bottom of the tank, a second data acquisition device may be located at or near the middle of the tank, and a third data acquisition device may be located at or near the top of the tank. In yet another embodiment, the tank can locate, situate, or arrange a first data acquisition device at or near the bottom of the tank, a second data acquisition device at or near a location equal to 25% of the total height of the tank, a third data acquisition device at or near a location equal to 50% of the height of the tank, a fourth data acquisition device at or near a location equal to 75% of the height of the tank, and a fourth data acquisition device located at (or near) the top of the tank.

In yet another embodiment, the tank can situate, or locate, one data acquisition device near the bottom of the tank, with additional data acquisition devices situated on the tank spaced at five-meter intervals all the way to the top of the tank. In yet another embodiment, the tank can comprise a first data acquisition device located near the bottom of the tank and locate additional data acquisition devices vertically spaced at one meter intervals spanning the full height of the tank. In yet another embodiment, the tank can comprise any number of data acquisition devices vertically spaced at intervals located from the bottom of the tank up to the top of the tank. A vertical arrangement of multiple data acquisition devices may improve the ability to accurately assess the consistency or homogeneity of the at least one property and/or characteristic throughout the fluid that is stored in the tank.

In some embodiments, there are a multitude of data acquisition devices that exist within the system. In some of these embodiments, the method omits data from data acquisition devices that provide malfunctioning or omitted data to the data analyzer. For example, in a situation where there are ten data acquisition devices within the system and the second device from the bottom of the tank incorrectly indicates that it is the upper height of liquid the tank (since it is not recognizing the presence fluid in the tank adjacent to the second data acquisition device), while the first, third, and fourth data acquisition devices detect the presence of fluid, then the data from the second device can be eliminated from consideration as an outlier by the programming of the data analyzer and not utilized in calculating the difference between the various measurements. In yet another example, if there are two or more parallel columns (or arrays) of vertically distributed data acquisition devices in the tank, and a pair of adjacent data acquisition devices within the tank do not accurately provide a measurement of the at least one characteristic of the fluid that are both within a certain defined range of each other, then the data obtained from those data acquisition devices may be excluded according to the programming run by the data analyzer.

Terms such as “within a pre-defined range of proximity” can be any range that is required by the tank operator utilizing any measurement units required for the chemical characteristic or physical property measured in the fluid. For example, in some embodiments, the term “approximates” is defined as a density difference between the measurements of less than 0.01 kg/m³, less than 0.5 kg/m³, less than 0.1 kg/m³, less than 0.2 kg/m³, less than 0.4 kg/m³, less than 0.5 kg/m³, less than 1 kg/m³, less than 5 kg/m³. In some embodiments, the term approximates is defined as when the first and the second measurements are within 0.01% of each other, within 0.05% of each other, within 0.1% of each other, within 0.5% of each other or within 1%, 2%, 3%, 4%, 5%, 6%, 7%, 8%, 9%, 10%, 15%, 20%, 25%, 30%, 45%, or even 50%.

When the first measurement “approximates” the second measurement, the intermittent mixer or mixers can be turned off. Similarly, when the first measurement is within a pre-defined range of proximity of the second measurement, the intermittent mixer (or mixers) is turned off. Conversely, when the first measurement exceeds a pre-defined range of proximity surrounding the second measurement, the data analyzer sends a data packet to the intermittent mixer (or mixers) instructing it to turn on.

Historically, custody transfer of fluids was performed by flowing fluid into a tank, followed by either allowing the tank fluids to settle or a tank mixer was turned on. When tank fluids were allowed to settle, different layers often form within the tank, each layer comprising significant differences in at least one chemical characteristic or physical property. The tank operator would have to manually determine the stratification of the layers and flow from the tank different layers of fluids until the desired fluid exited the tank. Alternatively, a tank mixer was continuously operated, and the operator would manually test the fluid within the tank upon dispensing to ensure the fluids were sufficient homogenization of chemical characteristics or physical properties. The present method allows for automatic detection of the degree of homogeneity (within a certain defined range) of the at least one chemical characteristic or physical property of the fluid within the tank, so that a downstream purchaser of the fluid can obtain a volume of the fluid knowing that the at least one characteristic of the fluid is consistent throughout. There is also significant cost savings through this approach since the tank mixer does not need to be continuously turned on. Additionally, there is significant time savings with this approach since operators do not have to wait for the tank to settle and stratify into different layers, each layer having a different value for the at least one characteristic.

The following examples of certain embodiments of the invention are given. Each example embodiment is provided to help explain various features and functions of the invention and are not intended to limit the scope of the invention to only the disclosed embodiments.

### Example 1

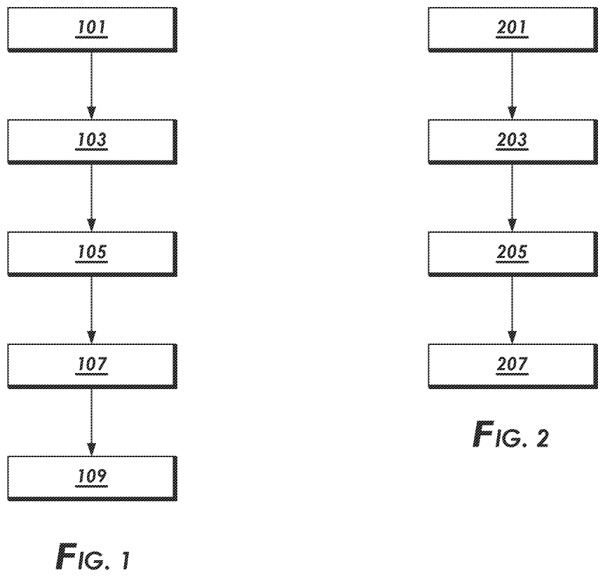

FIG. 1 is a flow diagram outlining a method of:
101—operating an upper data acquisition device in a tank containing a fluid, where the upper data acquisition device obtains a first measurement of at least one chemical characteristic and/or physical property of the fluid adjacent to the upper data acquisition device.
103—operating a lower data acquisition device, situated below the upper data acquisition device, where the lower data acquisition device obtains a second measurement of at least one chemical characteristic and/or physical property of the fluid in the tank adjacent to the lower data acquisition device.
105—utilizing a data analyzer comprising programming capable of receiving and comparing the first measurement and the second measurement to produce a data packet.
107—automatically turning on the intermittent mixer from the data received from the data packet.
109—automatically turning off the intermittent mixer from the information received from the data packet when the first measurement approximates the second measurement, wherein approximates is defined as a pre-defined range of proximity that may comprise either absolute units of the physical property and/or chemical characteristic or a percentage difference between the two measurements. This method can be repeated as many times as necessary to maintain the first measurement and the second measurement within the pre-defined range of proximity.

### Example 2

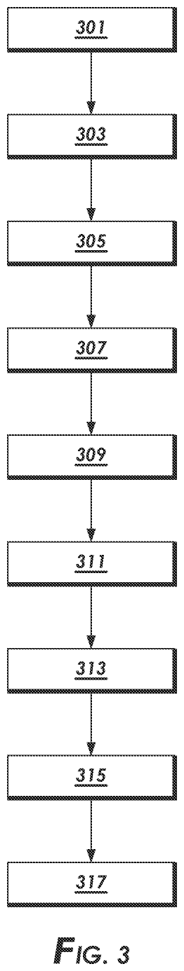

FIG. 2 is a flow diagram outlining a method of utilizing a data analyzer:
201—receiving a first measurement of at least one chemical characteristic and/or physical property of the fluid adjacent to an upper data acquisition device and receiving a second measurement at least one chemical characteristic and/or physical property of the fluid adjacent to a lower data acquisition device.
203—executing an algorithm that compares the first measurement to the second measurement.
205—executing an algorithm that generates a data packet that contains the calculated operational speed and operational time needed for the intermittent mixer to agitate the fluid so that the first measurement approximates the second measurement to within an acceptable pre-defined range of proximity (that may be either be expressed in absolute units or as a percentage difference between the measurements) for the chemical characteristic or physical property that is measured in the fluid.
207—transmitting the data packet to the intermittent mixer.

### Example 3

FIG. 3 is a flow diagram outlining a method of flowing a set volume of fluid from a tank wherein the characteristic of the fluid is consistent throughout the set volume of fluid.
301—flowing a fluid into a tank, wherein the fluid is a hydrocarbon fluid.
303—calculating an initial height of a fluid within a tank.
305—operating an upper data acquisition device capable of obtaining a first measurement at least one physical property or chemical characteristic of the fluid in the tank adjacent to the upper data acquisition device.
307—operating a lower data acquisition device, situated below the upper data acquisition device, capable of obtaining a second measurement of at least one physical property or chemical characteristic of the fluid in the tank adjacent to the lower data acquisition device.
309—utilizing a data analyzer capable of receiving and comparing the first measurement and the second measurement, then producing a data packet.
311—automatically turning on the intermittent mixer from the information received from the data packet.
313—automatically turning off the intermittent mixer from the information received from the data packet when the first measurement approximates the second measurement, wherein approximates is defined as a pre-defined range of proximity that may comprise either absolute units of the physical property and/or chemical characteristic or a percentage difference between the two measurements.
315—flowing a volume of fluid from the tank, wherein the at least one physical property and/or chemical characteristic of the fluid flowed from the tank is consistent (or within the pre-defined range of proximity) throughout the set volume of fluid.
317—calculating a secondary height of the fluid within the tank, wherein the volume of fluid flowed from the tank is calculated from the initial height and the secondary height.

Although the systems and processes described herein have been described in detail, various changes, substitutions, and alterations can be made to the embodiments without departing from the spirit and scope of the invention. Those having experience in the art may find that the inventive methods and systems described herein may manifest as other equivalent arrangements that are not specifically mentioned herein. Thus, the scope of the invention is not intended to be limited solely to the embodiments that are described and/or illustrated herein, but instead, by the claims that follow.

1. A method comprising:
flowing a volume of hydrocarbon fluid into a tank;
operating an upper data acquisition device positioned on the tank to obtain a first measurement of at least one physical property, at least one chemical characteristic, or at least one physical property and at least one chemical characteristic of the fluid that is adjacent to the upper data acquisition device;
operating a lower data acquisition device, positioned on the tank below the height of the upper data acquisition device, to obtain a second measurement at least one physical property, at least one chemical characteristic, or at least one physical property and at least one chemical characteristic of the fluid that is adjacent to the lower data acquisition device;
utilizing a data analyzer to:
receive and compare the first measurement and the second measurement;
generate a data packet that contains a calculated operational speed and operational time needed for an intermittent mixer to mix the fluid so that the first measurement is within a pre-defined range of proximity to the second measurement; and
transmitting the data packet to the intermittent mixer,
automatically turning on the intermittent mixer in response to information in the data packet that indicates the first measurement exceeds a pre-defined percentage difference relative to the second measurement;
automatically turning off the intermittent mixer in response to information in the data packet that indicates the first measurement is within a pre-defined percentage difference to the second measurement;
flowing a volume of fluid from the tank.

2. The method of claim 1, further comprising calculating an initial height of the fluid contained within the tank prior to the flowing of the volume of fluid from the tank and calculating a secondary height of the fluid within the tank after the flowing of the volume of fluid from the tank, wherein the volume of fluid flowed from the tank is calculated based on the initial height and the secondary height.

3. The method of claim 1, wherein the hydrocarbon fluid is selected from the group consisting of: gasoline, diesel fuel, heating oil, jet fuel, petrochemical feedstocks, waxes, lubricating oils, asphalt, and combinations thereof.

4. The method of claim 1, wherein the at least one chemical characteristic and/or physical property is selected from the group consisting of: density, specific gravity, temperature, specific volume, viscosity, molecular weight, flash temperature, octane number, research octane number, motor octane number, antiknock index, boiling point, molecular type composition, elemental composition, freezing point, carbon residue, pour point, cloud point, vapor pressure, Reid vapor pressure, flammability range, wax and asphaltene content, cetane number, aniline point, carbon-to-hydrogen ratio, additive ratio, and combinations thereof.

5. The method of claim 1, wherein the at least one data acquisition device intermittently or continuously measures the at least one chemical characteristic, at least one physical property or the at least one chemical characteristic and at least one physical property of the hydrocarbon fluid.

6. The method of claim 1, wherein the hydrocarbon fluid is an emulsion.

7. The method of claim 1, wherein the hydrocarbon fluid is a slurry.

8. The method of claim 1, wherein at least one of the upper data acquisition device, the lower data acquisition device, and the data analyzer, is an API approved custody transfer metering device.

9. The method of claim 1, wherein the pre-defined percentage difference between the first and the second measurements is selected from the list consisting of: less than 0.01% difference, less than 0.05% difference, less than 0.1% difference, less than 0.5% difference, less than 1% difference, less than 2% difference, less than 3% difference, less than 4% difference less than 5% difference, less than 6% difference, less than 7% difference, less than 8% difference, less than 9% difference, less than 10% difference, less than 15% difference, less than 20% difference, less than 25% difference, less than 30% difference, less than 45% difference, or less than 50% difference.

10. A method comprising:
flowing a volume of hydrocarbon fluid into a tank;
operating an upper data acquisition device positioned on the tank to obtain a first density measurement of the hydrocarbon fluid that is adjacent to the upper data acquisition device;
operating a lower data acquisition device, positioned on the tank below the height of the upper data acquisition device, to obtain a second density measurement of the fluid that is adjacent to the lower data acquisition device;
utilizing a data analyzer to:
receive and compare the first density measurement and the second density measurement;
generate a data packet that contains a calculated operational speed and operational time needed for an intermittent mixer to mix the fluid so that the first density measurement is within a pre-defined range of proximity to the second density measurement; and
transmitting the data packet to the intermittent mixer,
automatically turning on the intermittent mixer in response to information in the data packet that indicates the first density measurement exceeds a pre-defined range of density relative to the second density measurement;
automatically turning off the intermittent mixer in response to information in the data packet that indicates the first measurement is within a pre-defined range of density relative to the second density measurement;
flowing a volume of fluid from the tank.

11. The method of claim 10, further comprising calculating an initial height of the fluid contained within the tank prior to the flowing of the volume of fluid from the tank and calculating a secondary height of the fluid within the tank after the flowing of the volume of fluid from the tank, wherein the volume of fluid flowed from the tank is calculated based on the initial height and the secondary height.

12. The method of claim 10, wherein the hydrocarbon fluid is selected from the group consisting of: gasoline, diesel fuel, heating oil, jet fuel, petrochemical feedstocks, waxes, lubricating oils, asphalt, and combinations thereof.

13. The method of claim 10, wherein each data acquisition device intermittently or continuously measures the density of the hydrocarbon fluid.

14. The method of claim 10, wherein the hydrocarbon fluid comprises an emulsion.

15. The method of claim 10, wherein the hydrocarbon fluid comprises a slurry.

16. The method of claim 10, wherein at least one of the upper data acquisition device, the lower data acquisition device, and the data analyzer is an API approved custody transfer metering device.

17. The method of claim 10, wherein the pre-defined range between the first and the second density measurements is selected from the list consisting of: less than 0.01% difference, less than 0.05% difference, less than 0.1% difference, less than 0.5% difference, less than 1% difference, less than 2% difference, less than 3% difference, less than 4% difference less than 5% difference, less than 6% difference, less than 7% difference, less than 8% difference, less than 9% difference, less than 10% difference, less than 15% difference, less than 20% difference, less than 25% difference, less than 30% difference, less than 45% difference, or less than 50% difference.

18. The method of claim 10, wherein the pre-defined range between the first and the second density measurements is selected from the list consisting of: less than 0.001 kg/m³, 0.005 kg/m³, less than 0.01 kg/m³, less than 0.5 kg/m³, less than 0.1 kg/m³, less than 0.2 kg/m³, less than 0.4 kg/m³, less than 0.5 kg/m³, less than 1 kg/m³ and less than 5 kg/m³.
